(19) United States
(12) Patent Application Publication
(10) Pub. No.: US 2006/0123342 A1
(43) Pub. Date: Jun. 8, 2006

(54) System and method for creating generic, reusable, and dynamic application program configuration wizards

(75) Inventors: Edward M. Barton, Pleasanton, CA (US); Seema Gururaj, San Jose, CA (US); Delbert B. Hoobler III, Horseheads, NY (US); Carlos R. Perez, Watsonville, CA (US)

Correspondence Address: CARDINAL LAW GROUP, 1603 ORRINGTON AVENUE, SUITE 2000, EVANSTON, IL, 60201, US

(73) Assignee: International Business Machines Corporation, Armonk, NY (US)

(21) Appl. No.: 11/007,536

(22) Filed: Dec. 8, 2004

(51) Int. Cl. G06F 9/00

(52) U.S. Cl. 715/709; 715/788

(57) ABSTRACT

A configuration wizard module facilitates operations to configure an application without having any prior knowledge of the operational details of the application. To this end, the configuration wizard module receives page layout information indicative of a page layout of each configuration wizard page and configuration option data detailing the options of the configuration wizard page(s) to thereby render and display the configuration wizard pages based on the page layout information and the configuration option data, and receives and verifies user input data responsive to the displayed configuration wizard pages. Verified user option values stemming form the user input data is transmitted to the application to facilitate a validation of the verified user option values by the application, which can be configured upon validating all required user option values.

### FIELD OF INVENTION

The present invention generally relates to configuration wizards for applications. The present invention specifically relates to an efficient creation of a generic, reusable and dynamic configuration wizard for applications.

### BACKGROUND OF THE INVENTION

A storage manager protects an organization's data from hardware failures and other errors by storing backup/restore and archive/retrieve copies of data on offline storage sites. To this end, a storage manager can be a complex product composed of numerous and varied application having many different configuration parameters. As a result, it may be difficult for a user of the storage manager to easily configure each application in view of the numerous and varied options, settings and setup tasks the user must understand to configure each application. Moreover, it is time consuming and expensive for the provider of the storage manager to have to write and modify as needed a specific configuration wizard for each application and for each new version of a particular application. Furthermore, the cost of maintenance and support for an application can be significant. A challenge therefore for the computer industry is to develop a configuration wizard that is easy to use, flexible, extendable and transportable at a reduced development and service cost.

### SUMMARY OF THE INVENTION

The present invention provides a new and unique technique for developing a generic, reusable and dynamic configuration wizard for configuring an application without having any prior knowledge of the application.

One form of the present invention is a signal bearing medium tangibly embodying a program of machine-readable instructions executable by one or more processor(s) to perform operations to configure an application without any prior knowledge of the application. The operations include (1) receiving page layout information indicative of a page layout of a configuration wizard page for configuring the application, wherein the page layout information excludes executable instructions for rendering and displaying the configuration information; and (2) rendering and displaying the configuration wizard page based on the page layout information.

A second form of the present invention is system employing one or more processors, and one or more memories for configuring an application without any prior knowledge of the application. The instructions being executed for (1) receiving page layout information indicative of a page layout of a configuration wizard page for configuring the application wherein the page layout information excludes executable instructions for rendering and displaying the configuration information; and (2) rendering and displaying the configuration wizard page based on the page layout information.

A third form of the present invention is a system for configuring an application without any prior knowledge of the application. The system includes (1) means for receiving page layout information indicative of a page layout of a configuration wizard page for configuring the application, wherein the page layout information excludes executable instructions for rendering and displaying the configuration information; and (2) means for rendering and displaying the configuration wizard page based on the page layout information.

A fourth form of the present invention is a system comprising an application module and a configuration wizard module. The application module includes page layout information indicative of a page layout of a configuration wizard page for configuring the application, wherein the page layout information excludes executable instructions for rendering and displaying the configuration wizard page. The configuration wizard module receives the page layout information from the application module to thereby render and display the configuration wizard page based on the page layout information.

The forgoing forms and other forms, objects, and aspects as well as features and advantages of the present invention will become further apparent from the following detailed description of the various embodiments of the present invention, read in conjunction with the accompanying drawings. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates an exemplary embodiment of a configuration wizard system in accordance with the present invention;

FIG. 2 illustrates flowcharts representative of one embodiment of a configuration wizard creation method in accordance with the present invention;

FIG. 3 illustrates one embodiment of a configuration wizard module and an application module in accordance with the present invention;

FIG. 4 illustrates a flowchart representative of one embodiment in accordance with the present invention of the flowchart illustrated in FIG. 2; and

FIGS. 5-8 illustrates exemplary callbacks during an execution of the flowchart illustrated in FIG. 4.

### DETAILED DESCRIPTION OF THE PRESENT INVENTION

A configuration wizard system of the present invention employs a completely generic configuration wizard module of the present invention and a conventional application module modified in accordance with the present invention, where the configuration wizard module is ignorant of any specific details of the application code of the application module. Specifically, the application module is modified to include page layout information indicative of a page layout of each configuration wizard page associated with configuring the application code of the application module, where the page layout information excludes executable instructions for rendering and displaying the configuration wizard page(s), and configuration option data as necessary to dynamically populate each configuration wizard page. The configuration wizard module is software designed to interact with the application module to receive the page layout information and any required configuration option data to thereby render and display configuration wizard pages for purposes of obtaining user input data for configuring the application code of the application module.

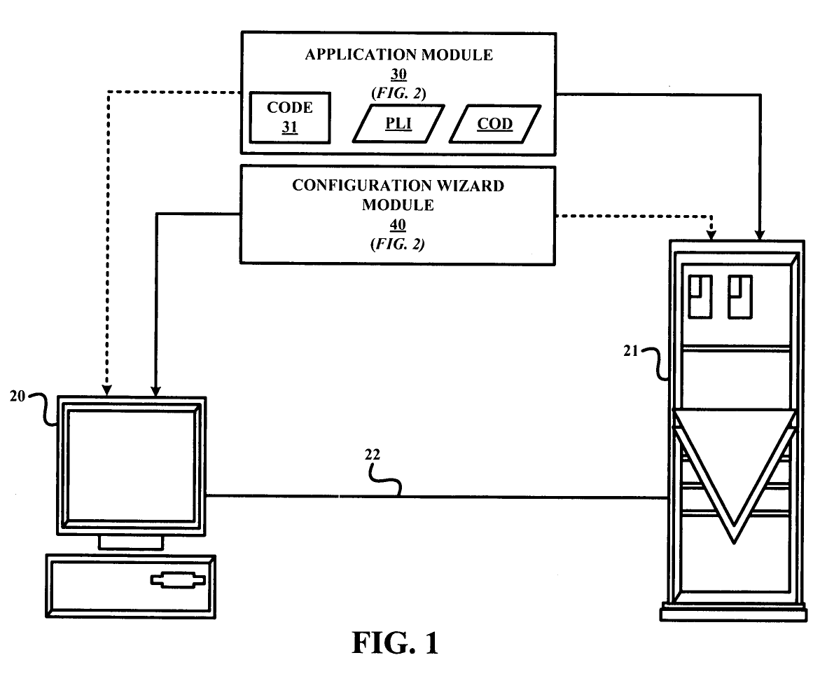

FIG. 1 illustrates an exemplary implementation of a configuration wizard system of the present invention involving a computer environment consisting of a client 20 and a server 21 connected via a connection 22, which can range from a simple connection like a wireline connection or wireless connection to a more complex connection involving the interconnections of numerous nodes (e.g., a local area network and a wide area network). Alternatively, client 20 can reside on server 21.

The system further includes an application module 30 installed on server 21 as indicated by the solid arrow and a configuration wizard module 40 installed on client 20 as indicated by the solid arrow. Alternatively, application module 30 may be installed on client 20 as indicated by the dashed arrow and/or configuration wizard module 40 may be installed on server 21 as indicated by the dashed arrow.

Application module 30 is representative of a conventional application including application code 31 for conventionally providing a particular service and/or performing a particular task or tasks upon a configuration of application code 31. Application module 30 has been modified in accordance with the present invention to include new and unique page layout information PLI indicative of a page layout of each configuration wizard page associated with configuring application module 30, and new and unique configuration option data COD as needed to dynamically populate each configuration wizard page. Configuration wizard module 40 includes hardware, software and/or firmware configured to read page layout information PLI and gather configuration option data COD as needed to thereby render and display each configuration wizard page on client 20 whereby a user of client 20 can configure application code 31 as desired.

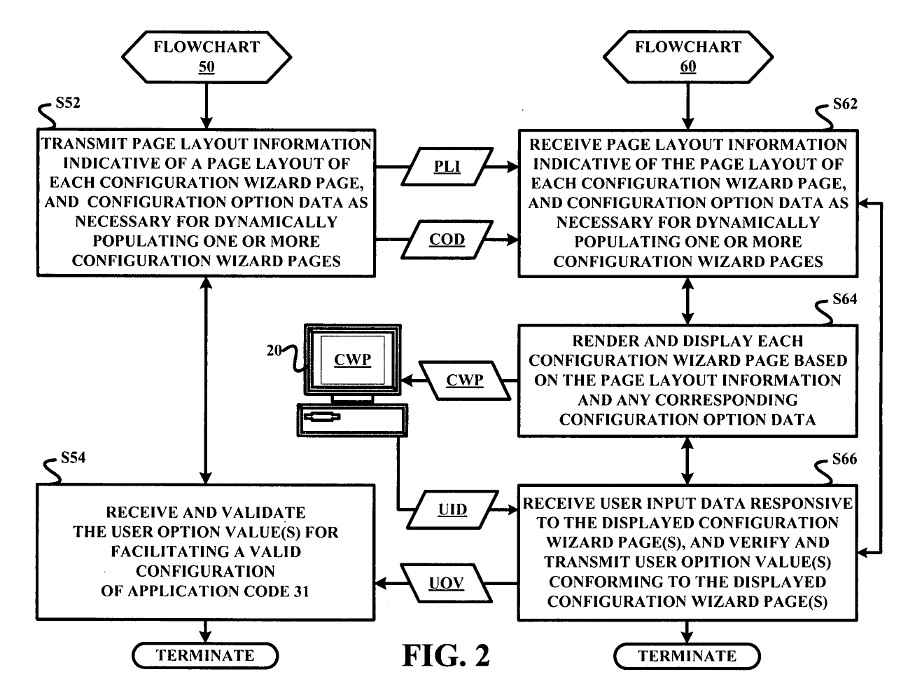

In one embodiment, page layout information PLI is a generic standard format exclusive of executable instructions that is written in a specialized language to be read by configuration wizard module 40 for rendering and displaying each configuration wizard page whereby the generic standard format eliminates a need to conventionally write executable instructions in application code 30 for each configuration wizard page. As such, page layout information PLI is not owned by application module 30 in the context of being tied to a particular version of application code 31. Thus, page layout information PLI can be created, tested and maintained for facilitating a configuration of application module 30 in the context of an essentially limitless variations of application code 31. Those having ordinary skill in the art will appreciate these advantages of the present invention from the following description of FIGS. 2-8.

Referring to FIG. 2, a flowchart 50 and a flowchart 60 as shown are representative of a configuration wizard creation method of the present invention. An execution by application module 30 and configuration wizard module 40 of flowchart 50 and flowchart 60, respectively, will now be described in detail herein. From this straightforward description of the execution of flowcharts 50 and 60, those having ordinary skill in the art will appreciate the implementation of the configuration wizard creation method of the present invention in the context of other computer environments in addition to the one shown in FIG. 1.

Referring to FIGS. 1 and 2, a stage S52 of flowchart 50 and a stage S62 of flowchart 60 encompasses a communication from application module 40 to configuration wizard module 50 of page layout information PLI indicative of a page layout of each configuration wizard page associated with configuring application code 31 of application module 30, and of configuration option data COD as needed to dynamically populate one or more configuration wizard pages.

A stage S64 of flowchart 60 encompasses configuration wizard module 40 rendering and controlling a display of each configuration wizard page CWP on client 20 based on page layout information PLI and any corresponding configuration option data COD. In one embodiment involving an option for a give configuration wizard page CWP, configuration wizard module 40 generates two or more dynamic field values for the option whereby a user of client 20 can choose from among the fields values of the option. In a second embodiment involving an option for a give configuration wizard page CWP, configuration wizard module 40 facilitates a user of client 20 entering a field value for the option within a specific parameter range of the option.

A stage S66 of flowchart 60 encompasses configuration wizard module 40 receiving user input data UID entered into client 20 by a user in response to the displayed configuration wizard page(s), and verifying and transmitting one or more user option values UOV obtained from the user input data UID in conformance with the displayed configuration wizard page(s) to application module 30. In one embodiment, user option value(s) UOV obtained from the user input data UID are automatically verified as being in conformance with a displayed configuration wizard page having dynamic field values for a particular option whereby a user of client 20 selects a field value from among the displayed field values. In a second embodiment, a particular option of the displayed configuration wizard page will have a specified parameter range whereby configuration wizard module 40 will only verify the user option value(s) UOV being in conformance with the displayed configuration wizard page when the field value entered by the user is within the specified parameter range of a particular option.

A stage S54 of flowchart 50 encompasses application module 30 receiving verified user option value(s) UOV in conformance with the displayed configuration wizard pages, and validating user option value(s) UOV for facilitating a configuration of application code 31. In one embodiment, all options are independent of each other and the validation of user option value(s) UOV for facilitating a configuration of application code 31 is automatic. In a second embodiment, two or more options are dependent upon each other. Thus, a selection or entering of a verified field value for a particular option by the user may be prohibited in the context of a selection or entering of a verified field value of another option. In such a case, application module 30 will inform configuration wizard module 40 of new parameters for the invalid option whereby configuration wizard module 40 will gather new user option value(s) UOV for that particular option within the parameters set forth by application module 30. This process will be repeated until all of user option value(s) UOV is verified by configuration wizard module 40 and validated by application module 30.

As indicated by the solid bi-directional arrows, application module 30 will proceed between stages S52 and S54 and configuration wizard module 40 will proceed among stages S62-S66 as required to gather all of option value(s) UOV necessary for facilitating a configuration of application code 31 of application module 30. Upon gathering all required and valid user option value(s) UOV, flowcharts 50 and 60 are terminated to thereby enable a configuration of application code 31 based all of the valid option value(s) UOV.

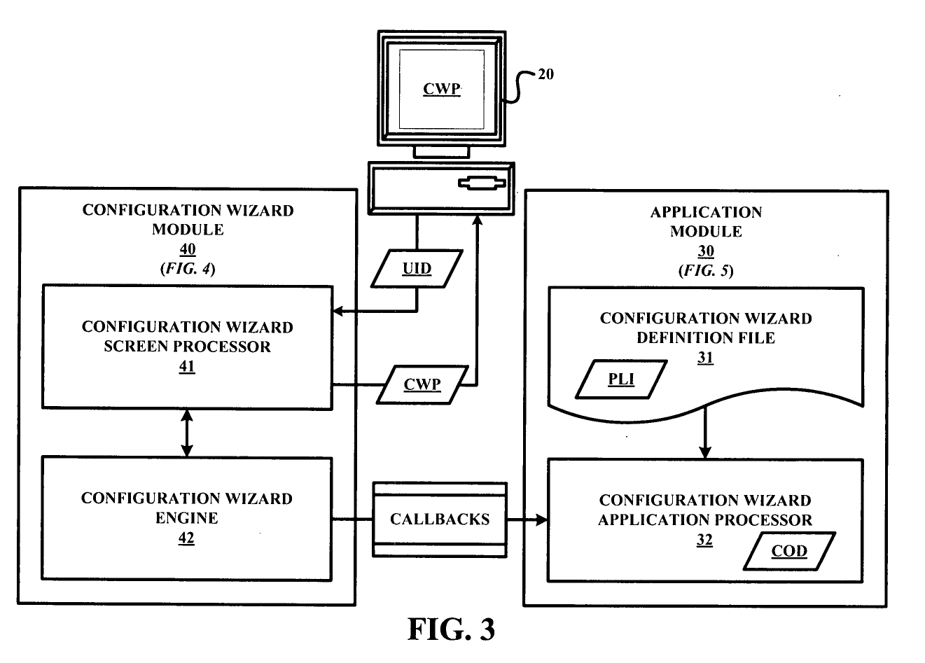

In practice, the manner by which modules 30 and 40 implement flowcharts 50 and 60 are without limit. Thus, the following description of one embodiment of application module 30 and one embodiment of configuration wizard module 40 as illustrated in FIG. 3 is not a limitation as to the scope of modules 30 and 40.

Referring to FIG. 3, configuration wizard module 40 employs a configuration wizard screen processor 41 for controlling a display of each configuration wizard page CWP on client 20, gathering user input data in the form of user option values UOV as inputted by a user of client 20, and performing validation of the gathered user option values UOV in the context of whether the user option values conform with the configuration wizard pages. Configuration wizard module 40 further employs a configuration engine wizard 42 for rendering each configuration wizard page CWP, driving processor 41 in controlling the display of each configuration wizard page CWP on client 20, and executing callbacks for obtaining page layout information PLI and gathering configuration option data COD as needed from application module 30.

Application module 30 stores a configuration wizard definition file 31 including page layout information PLI, and a configuration wizard application processor 32 including configuration option data COD as needed. Processor 32 executes callbacks from engine 42 to thereby provide engine 42 with page layout information PLI and configuration option data COD as needed.

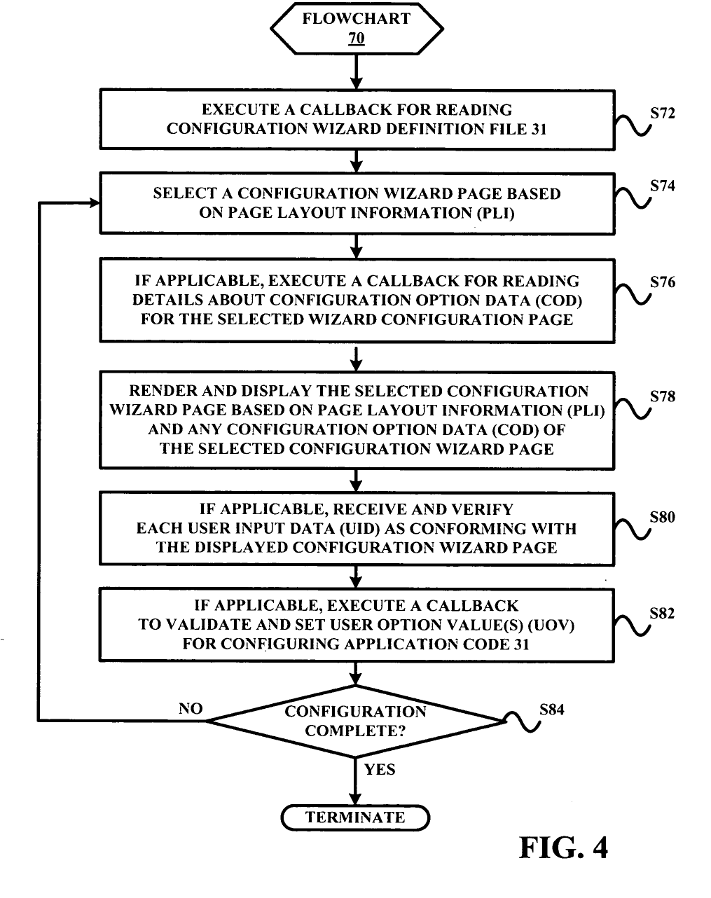

In performing their tasks, processor 32 and engine 42 collectively implement a flowchart 70 as illustrated in FIG. 4.

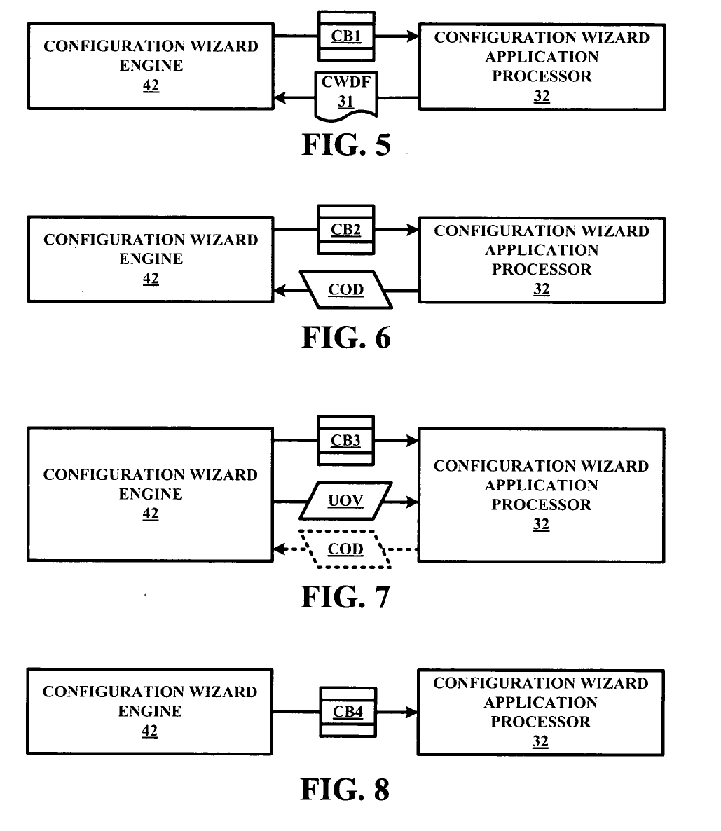

Referring to FIGS. 3 and 4, a stage S72 of flowchart 70 encompasses engine 42 issuing a callback to processor 32 for requesting configuration wizard definition file 31 be transmitted by processor 32 to engine 42 whereby engine 42 reads configuration wizard definition file 31 to ascertain page layout information PLI. For example, as illustrated in FIG. 5, engine 42 issues a callback CB1 to processor 32, and in response thereto, processor 32 transmits configuration wizard definition file 31 to engine 42.

Upon obtaining page layout information PLI, engine 32 proceeds to a stage S74 of flowchart 70 to select one of the configuration wizard pages based on the page layout information PLI. As previously described herein, in one embodiment, page layout information PLI is a generic standard format written in a specialized language to be read by configuration wizard module 40 for rendering each configuration wizard page. Thus, during stage S74, engine 42 reads the page layout information PLI to thereby select one of the configuration wizard pages.

If the selected configuration wizard page does not have options (which will typically be the case for the first one to three displayed configuration wizard pages as well as the last displayed configuration wizard page), then a stage S76 of flowchart 70 is bypassed. Otherwise, if applicable, stage S76 encompasses engine 42 issuing a callback to processor 32 for requesting configuration option data COD representing details about each option of the selected configuration wizard page. For example, as illustrated in FIG. 6, engine 42 issues a callback CB2 to processor 32, and in response thereto, processor 32 transmits configuration option data COD corresponding to the selected configuration wizard page.

A stage S78 of flowchart 70 encompasses engine 42 rendering the selected configuration wizard page based on page layout information PLI and the corresponding configuration option data COD, if any, and engine 42 driving a display of the rendered configuration wizard page as controlled by processor 41.

If the selected configuration wizard page does not have options, then a stage S80 of flowchart 70 is bypassed. Otherwise, stage S80 encompasses processor 41 receiving and verifying each user option value UOV as conforming with an option of the displayed configuration wizard option page. As previously described herein, the verification can be automatic for dynamic field values of a option of the displayed configuration wizard option page whereby a user of client 20 can choose from among the fields values, or a particular option of the displayed configuration wizard page will have the specified parameter range whereby processor 41 will only verify each user option value UOV being in conformance with the displayed configuration wizard page when the field value(s) entered by the user is within the specified parameter range of the option(s) of the displayed configuration wizard page.

If the displayed configuration wizard page does not have options, then a stage S82 of flowchart 70 is bypassed. Otherwise, stage S82 encompasses engine 42 issuing a callback to processor 32 for requesting a validation and setting of user option value(s) UOV received and verified during stage S80. For example, as illustrated in FIG. 7, engine 42 issuing a callback CB3 and user option value(s) UOV to processor 32, and in response thereto, processor 32 validates and sets user option value(s) UOV for the option of the displayed configuration wizard page unless the user option value(s) UOV are invalid for configuring application code 31. In one embodiment, the validation and setting of a user option value UOV can be automatic if each option of the displayed configuration wizard page is not dependent upon a selected value of any other option of all configuration wizard pages. In a second embodiment, the validation and setting of a user option value UOV of an option that is dependent upon or affects parameters of any other option of all configuration wizard pages involves processor 32 either validating and setting the user option value UOV of the option upon initially receiving the user option value UOV if the user option value UOV is valid in view of the parameters of all of the other options, or processor 32 transmitting new configuration option data COD as illustrated in FIG. 7 to engine 42 that has valid parameters for the option.

If the gathering of all user option value(s) UOV for configuring application module 30 is not complete upon a first pass of stages S74-S82, then a stage S84 of flowchart 80 encompasses an execution of stages S74-S82 for another configuration wizard page. Otherwise, stage S82 encompasses engine 42 issuing a call command to processor 31 for notifying processor 32 that all of the user option value(s) UOV for configuring application module 30 has been gathered. For example, as illustrated in FIG. 8, engine 42 issues a call command CB4 to processor 32 whereby processor 32 in response thereto commences with configuring application code 31 based on the verified and validated user option value(s) UOV.

From the preceding description of FIGS. 1-4, those having ordinary skill in the art will appreciate numerous advantages of the present invention. Foremost among such advantages is creation of generic, reusable and dynamic configuration wizard pages.

In one practical embodiment, module 30 (FIGS. 1 and 3) and module 40 (FIGS. 1 and 3) can be embodied in a software module integrated with a commercially available software application entitled “IBM Tivoli Storage Manager”. As such, module 30 and module 40 are installed within a memory of a server/client or distributed among various server/client memories whereby server/client processor(s) can execute module 30 and module 40 to perform various operations of the present invention as exemplary illustrated in FIG. 2 and/or FIG. 4. Module 30 and module 40 can be written in any conventional programming language by those having ordinary skill in the art appreciating the description herein of FIGS. 1-4. As related to software application entitled “IBM Tivoli Storage Manager”, one embodiment of callback CB1 (FIG. 5) is as a cwAppInit( ) instruction for requesting configuration wizard definition file 31 (FIG. 3), one embodiment of callback CB2 (FIG. 6) is as a cwAppGetOptions( ) instruction for requesting option information for a selected configuration wizard page to be displayed, one embodiment of callback CB3 (FIG. 7) is as a cwAppSetOptions( ) instruction for setting the options received from the display of the configuration wizard page, and one embodiment of callback CB4 (FIG. 8) is as a cwAppTerm( ) instruction for notifying application module 30 that all of the necessary and valid user option values have been gathered.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A signal bearing medium tangibly embodying a program of machine-readable instructions executable by at least one processor to perform operations to configure an application without any prior knowledge of the application, the operations comprising:
receiving page layout information indicative of a page layout of a configuration wizard page for configuring the application, wherein the page layout information excludes executable instructions for rendering and displaying the configuration wizard page; and
rendering and displaying the configuration wizard page based on the page layout information.

2. The signal bearing medium of claim 1, wherein receiving the page layout information includes:
executing a callback to the application for a configuration wizard definition file including the page layout information.

3. The signal bearing medium of claim 1, wherein the operations further comprise:
receiving configuration option data detailing an option of the configuration wizard page, wherein the configuration wizard page is rendered and displayed based on the page layout information and the configuration option data.

4. The signal bearing medium of claim 3, wherein receiving the configuration option data includes:
executing a callback to the application for the configuration option data.

5. The signal bearing medium of claim 3, wherein the operations further comprise:
receiving and verifying user input data responsive to a display of the configuration wizard page.

6. The signal bearing medium of claim 5,
wherein the verified user input data includes at least one verified user option value; and
wherein the operations further comprise transmitting the at least one verified user option value to the application.

7. The signal bearing medium of claim 6, wherein transmitting the at least one verified user option value to the application includes:
executing a callback to the application to validate at least one verified user option value.

8. A system, comprising:
at least one processor; and
at least one memory storing instructions operable with the at least one processor for configuring an application without any prior knowledge of the application, the instructions being executed for:
receiving page layout information indicative of a page layout of a configuration wizard page for configuring the application, wherein the page layout information excludes executable instructions for rendering and displaying the configuration wizard page; and
rendering and displaying the configuration wizard page based on the page layout information.

9. The system of claim 8, wherein receiving the page layout information includes:
executing a callback to the application for a configuration wizard definition file including the page layout information.

10. The system of claim 8, wherein the instructions are further executed for:
receiving configuration option data detailing an option of the configuration wizard page, wherein the configuration wizard page is rendered and displayed based on the page layout information and the configuration option data.

11. The system of claim 10, wherein receiving the configuration option data includes:
executing a callback to the application for the configuration option data.

12. The system of claim 10, wherein the instructions are further executed for:
receiving and verifying user input data responsive to a display of the configuration wizard page.

13. The system of claim 12,
wherein the verified user input data includes at least one verified user option value; and
wherein the operations further comprise transmitting the at least one verified user option value to the application.

14. The system of claim 13, wherein transmitting the at least one verified user option value to the application includes:
executing a callback to the application to validate the at least one verified user option value.

15. A system for configuring an application without any prior knowledge of the application, comprising:
means for receiving page layout information indicative of a page layout of a configuration wizard page for configuring the application, wherein the page layout information excludes executable instructions for rendering and displaying the configuration wizard page; and
means for rendering and displaying the configuration wizard page based on the page layout information.

16. The system of claim 15, further comprising:
means for receiving configuration option data from the application detailing an option of the configuration wizard page, wherein the configuration wizard page is rendered and displayed based on the page layout information and the configuration option data.

17. A system, comprising:
an application module including page layout information indicative of a page layout of a configuration wizard page for configuring the application, wherein the page layout information excludes executable instructions for rendering and displaying the configuration wizard page; and
a configuration wizard module in electrical communication with the application module to receive the page layout information, the configuration wizard module being operable to render and display the configuration wizard page based on the page layout information.

18. The system of claim 17, wherein the configuration wizard module is further operable to execute a callback to the application module for a configuration wizard definition file including the page layout information.

19. The system of claim 17, wherein the configuration wizard module is in electrical communication with the application module to further receive configuration option data detailing an option of the configuration wizard page; and
wherein the configuration wizard module is further operable to render and display the configuration wizard page based on the page layout information and the configuration option data.

20. The system of claim 19, wherein the configuration wizard module is further operable to execute a callback to the application for the configuration option data.

21. The system of claim 19, wherein the configuration wizard module is further operable to receive and verify user input data responsive to a display of the configuration wizard page.

22. The system of claim 21,
wherein the verified user input data includes at least one verified user option value; and
wherein the configuration wizard module is further operable to transmit the at least one verified user option value to the application.

23. The system of claim 22, wherein transmitting the at least one verified user option value to the application includes:
executing a callback to the application to validate the at least one verified user option value.
